(19) United States
(12) Patent Application Publication
(10) Pub. No.: US 2018/0111409 A1
(43) Pub. Date: Apr. 26, 2018

(54) DECORATION DEVICE AND DECORATION METHOD

(71) Applicant: Roland DG Corporation, Hamamatsu-shi (JP)

(72) Inventor: Fumihiro TAKAHASHI, Hamamatsu-shi (JP)

(21) Appl. No.: 15/792,796

(22) Filed: Oct. 25, 2017

(30) Foreign Application Priority Data
Oct. 26, 2016 (JP) 2016-209923

(51) Int. Cl. B44B 5/00

(52) U.S. Cl. CPC B44B 5/0052; B44C 1/1729

(57) ABSTRACT

A decoration device decorates a decoration subject by foil transfer and imprinting and includes a holding table holding the decoration subject, at least one grasping tool grasping a foil transfer tool and/or an imprinting tool at the same time or selectively, a conveyor moving one of the holding table and the at least one grasping tool with respect to the other, and a controller driving the at least one grasping tool and the conveyor. The controller defines or includes a foil transfer controller executing foil transfer control and an imprinting controller executing imprinting control before and/or after the foil transfer control by the foil transfer controller.

### CROSS REFERENCE TO RELATED APPLICATIONS

This application claims the benefit of priority to Japanese Patent Application No. 2016-209923 filed on Oct. 26, 2016. The entire contents of this application are hereby incorporated herein by reference.

### BACKGROUND OF THE INVENTION

### 1. Field of the Invention

The present invention relates to a decoration device and a decoration method, and more specifically, to a decoration device and a decoration method for decorating a decoration subject by foil transfer and imprinting.

### 2. Description of the Related Art

Conventionally, processing technologies of foil transfer that utilize a foil sheet (transfer sheet) such as a metal foil, a pigment foil or the like are known to be used for the purpose of, for example, improving the creativity of design. Regarding such a technology, Japanese Laid-Open Patent Publication No. 2005-313465 describes a foil transfer method of a thermal transfer system (hot stamping method). According to this method, a hot stamp foil is put on a decoration subject, and a heated pen is pressed onto the hot stamp foil, so that a desired pattern is formed on a surface of the decoration subject.

In foil transfer, the state of a surface of a decoration subject (e.g., inclination or ruggedness of the surface) significantly influences the finished state. Therefore, the metallic tone, luster, hue or the like of the finished pattern on the decoration subject may be different from what a user desires. In addition, regarding the decoration of a subject, it is now desired to increase the diversity of representation to realize a variety of creative designs in conformity to the user's wishes.

### SUMMARY OF THE INVENTION

Preferred embodiments of the present invention provide novel decoration devices and novel decoration methods capable of providing any of a variety of creative designs to a decoration subject.

A decoration device for decorating a decoration subject by foil transfer and imprinting according to a preferred embodiment of the present invention includes a holding table holding the decoration subject; at least one grasping tool grasping a foil transfer tool and/or an imprinting tool at the same time or selectively; a conveyor moving one of the holding table and the at least one grasping tool with respect to the other of the holding table and the at least one grasping tool; and a controller communicably connected with the at least one grasping tool and the conveyor, the controller being configured or programmed to drive the at least one grasping tool and the conveyor. The controller includes a foil transfer controller configured or programmed to move the grasping tool grasping the foil transfer tool and the holding table with respect to each other by use of the conveyor to execute foil transfer control to perform foil transfer onto the decoration subject; and an imprinting controller configured or programmed to move the grasping tool grasping the imprinting tool and the holding table with respect to each other by use of the conveyor to execute imprinting control to perform imprinting onto the decoration subject. The imprinting controller is configured or programmed to execute the imprinting control at least either before the foil transfer control by the foil transfer controller or after the foil transfer control by the foil transfer controller.

According to the above-described decoration device, a pattern is provided to a decoration subject by foil transfer. In addition, the state of a surface of the decoration subject is changed by imprinting, so that any of various types of representations, patterns, images, etc. is provided to the decorated subject. Therefore, in the case where the user is not satisfied by the appearance of the pattern obtained by mere foil transfer, the user may freely change the state of light reflection by imprinting so as to adjust how the pattern appears. Furthermore, a combination of foil transfer and imprinting realizes a wide variety of creative designs, and the diversity of design or representation is increased, unlike only foil stamping is used. Therefore, any of a wide variety of wishes of the user is realized to improve the degree of satisfaction of the user.

A decoration method for decorating a decoration subject according to a preferred embodiment of the present invention includes a foil transfer step of performing foil transfer to the decoration subject; and an imprinting step of performing imprinting on the decoration subject before or after the foil transfer step.

Decoration devices and decoration methods according to preferred embodiments of the present invention provide any of a variety of creative designs to a decoration subject by foil transfer and imprinting.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically showing a decoration device according to a preferred embodiment of the present invention.

FIG. 2 is a partially cut perspective view schematically showing a form of the decoration device during a decoration operation.

FIG. 3 is a left side view schematically showing conveyors according to a preferred embodiment of the present invention.

FIG. 4 is a flowchart showing a decoration method according to a preferred embodiment of the present invention.

FIG. 5 is a perspective view schematically showing a decoration device according to another preferred embodiment of the present invention.

FIG. 6 is a side view schematically showing a structure of a foil transfer tool according to a preferred embodiment of the present invention.

### DETAILED DESCRIPTION OF THE PREFERRED EMBODIMENTS

Hereinafter, preferred embodiments according to the present invention will be described with reference to the attached drawings optionally. The preferred embodiments of the present invention described below are not intended to specifically limit the present invention. Components and portions that have the same functions will bear the same reference signs, and overlapping descriptions will be omitted or simplified optionally.

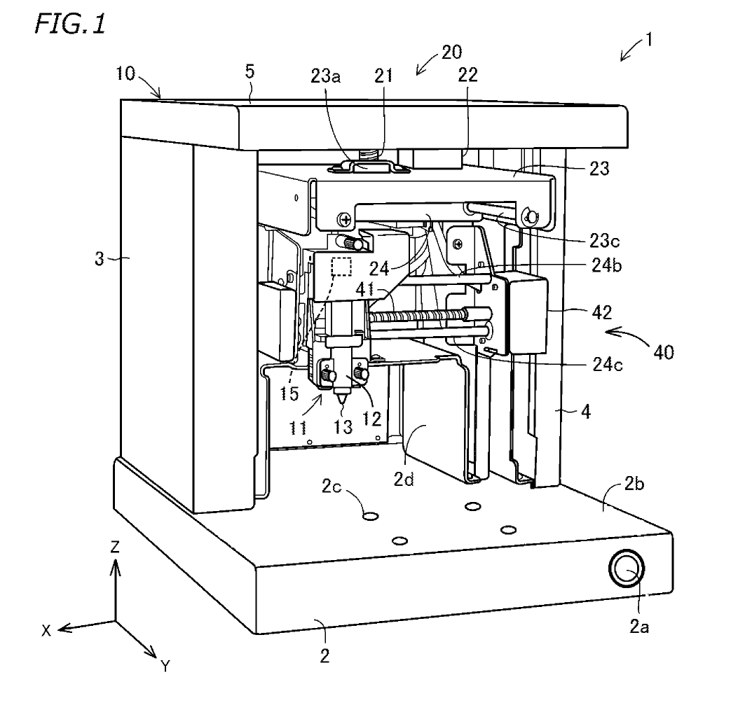

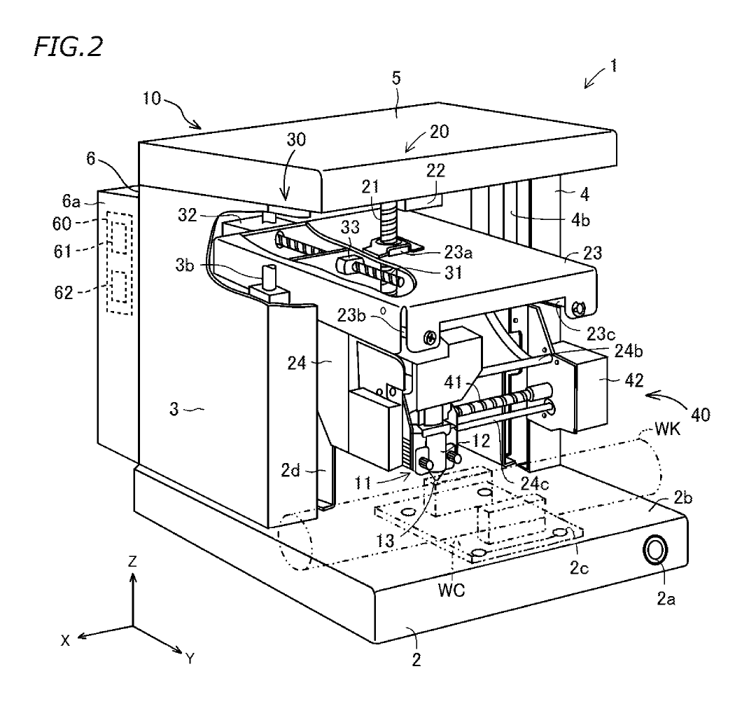

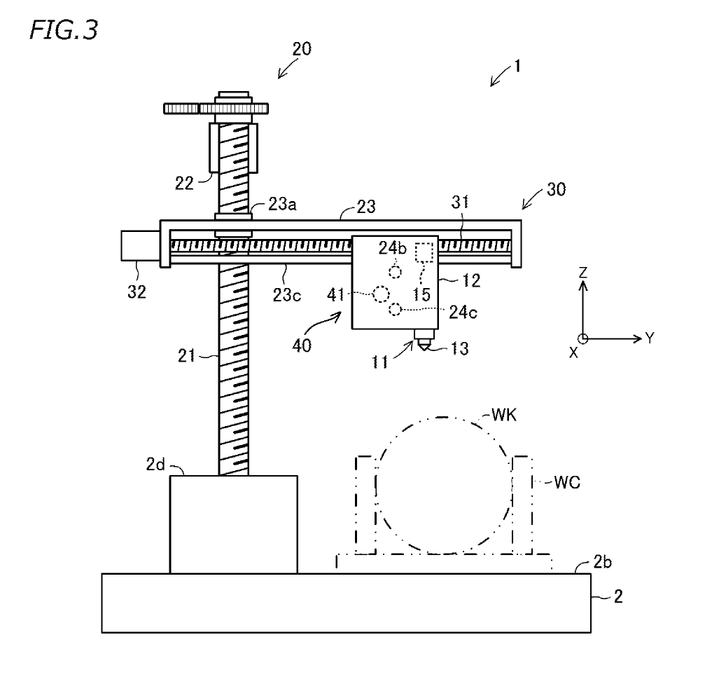

First, a structure of a decoration device 1 will be described. FIG. 1 is a perspective view of the decoration device 1. FIG. 2 is a partially cut perspective view schematically showing a form in which the decoration device 1 is performing a decoration operation. FIG. 3 is a left side view schematically showing conveyors 20, 30 and 40. The decoration device 1 according to this preferred embodiment is put on a plane defined by an X axis and a Y axis in the state where the X-axis, the Y axis and a Z axis cross each other perpendicularly. Hereinafter, “left” and “right” are left and right for a user facing a power switch 2a of the decoration device 1 in FIG. 1. A direction in which the user facing the power switch 2a approaches the power switch 2a is defined as “rearward”, and a direction in which the user is distanced away from the power switch 2a is defined as “forward”. These directions are defined merely for the sake of illustration, and do not limit the form of installation of the decoration device 1 in any way.

The decoration device 1 is a device that presses a hot stamp onto a work WK, which is a decoration subject, to transfer the pattern of the hot stamp, or forms imprinting indentations in the work WK, and thus gives creativity of design to the work WK. There is no specific limitation on the type of the work WK. The work WK may be, for example, an item of a metal material such as gold, silver, copper, platinum, brass, aluminum, iron, titanium, stainless steel or the like; a resin material such as acrylic resin, poly(vinylchloride) (PVC), polyethyleneterephthalate (PET), polycarbonate (PC) or the like; a paper material such as plain paper, drawing paper, Washi (traditional Japanese hand-made paper) or the like; rubber; or the like. From the point of view of ease of decoration, the Vickers hardness (HV) of a surface, of the work WK, to be decorated may be about 200 or less, for example, about 100 or less. The Vickers hardness may be measured in conformity to, for example, the Japanese Industrial Standards (JIS), Z 2244: 2009. In this preferred embodiment, the decoration device 1 is box-like. The decoration device 1 includes a case 10 opened forward. The case 10 includes a base 2, a left wall 3, a right wall 4, a ceiling 5, and a rear wall 6. The case 10 may be formed of, for example, a copper plate.

The base 2 is a holding table on which the work WK is to be placed. A front region of the base 2 is a work carrying region 2b on which the work WK is to be placed. A central region of the work carrying region 2b is provided with four attachment holes 2c. The attachment holes 2c are usable to attach a securing tool (e.g., vice) holding the work WK. On a front surface of the base 2, the power switch 2a is provided.

The left wall 3 extends upward from a left end of the base 2. The left wall 3 is provided vertically to the base 2. The right wall 4 extends upward from a right end of the base 2. The right wall 4 is provided vertically to the base 2. The left wall 3 and the right wall 4 support a carriage 11 described below. The rear wall 6 extends upward from a rear end of the base 2. The rear wall 6 is connected with a rear end of the left wall and a rear end of the right wall 4. A box-shaped controller 6a is provided to the rear of the rear wall 6. The controller 6a accommodates a controller 60 described below. The ceiling 5 is connected with a top end of the left wall 3, a top end of the right wall 4 and a top end of the rear wall 6. On the ceiling 5, a portion of a Z-axis direction conveyor 20 (described below) is located. A space surrounded by the base 2, the left wall 3, the right wall 4, the ceiling 5 and the rear wall 6 is an inner space of the case 10.

The inner space of the case 10 is a space where a hot stamp is pressed onto the work WK or imprinting indentations are formed in the work WK. In the inner space, the carriage 11 and a conveyor moving the carriage 11 in three-dimensional directions are provided. The conveyor moving the carriage 11 includes the Z-axis direction conveyor 20, a Y-axis direction conveyor 30, and an X-axis direction conveyor 40. The carriage 11 is movable with respect to the work WK by the conveyors 20, 30 and 40. The conveyors 20, 30 and 40 are located above the base 2. Therefore, even if cutting chips, dust or the like is generated during the decoration operation on the work WK, the movement of the carriage 11 is not much influenced.

The Z-axis direction conveyor 20 preferably is a feed screw mechanism including a Z-axis direction feed screw rod 21, a Z-axis direction feed motor 22, and a feed nut 23a. The Z-axis direction feed screw rod 21 extends in the Z-axis direction. The Z-axis direction feed screw rod 21 is provided with a spiral screw groove. A top portion of the Z-axis direction feed screw rod 21 is secured to the ceiling 5. A top end of the Z-axis direction feed screw rod 21 passes a bottom surface of the ceiling 5 in the Z-axis direction, and a part thereof is located inside the ceiling 5. A bottom end of the Z-axis direction feed screw rod 21 is rotatably supported by a support frame 2d. The support frame 2d is secured on the base 2. The Z-axis direction feed motor 22 is an electric motor. The Z-axis direction feed motor 22 is connected with the controller 60. The Z-axis direction feed motor 22 is secured to the ceiling 5. A driving shaft of the Z-axis direction feed motor 22 passes the bottom surface of the ceiling 5 in the Z-axis direction, and a portion thereof is located inside the ceiling 5. Inside the ceiling 5, the Z-axis direction feed screw rod 21 is coupled with the Z-axis direction feed motor 22. The Z-axis direction feed motor 22 rotates the Z-axis direction feed screw rod 21.

The Z-axis direction feed screw rod 21 is geared with the feed nut 23a including threads. The feed nut 23a is coupled with an elevation base 23. The feed nut 23a passes a top surface of the elevation base 23 in the Z-axis direction. The elevation base 23 is supported by the Z-axis direction feed screw rod 21 via the feed nut 23a. The elevation base 23 is parallel or substantially parallel to the base 2. Lengths of the elevation base 23 in the X-axis direction and the Y-axis direction are respectively longer than lengths of the work carrying region 2b in the X-axis direction and the Y-axis direction. Inner to the left wall 3 and the right wall 4, a slide shaft 3b and a slide shaft 4b are respectively provided such that the elevation base 23 is slidable along the slide shafts 3b and 4b. The slide shafts 3b and 4b are parallel or substantially parallel to the Z-axis direction feed screw rod 21. When the Z-axis direction feed motor 22 is driven, the Z-axis direction feed screw rod 21 is rotated, and thus the elevation base 23 moves upward and downward along the slide shafts 3b and 4b. The Y-axis direction conveyor 30 and the X-axis direction conveyor 40 are coupled with the elevation base 23. Therefore, the Y-axis direction conveyor 30 and the X-axis direction conveyor 40 move in the Z-axis direction integrally with the elevation base 23 along with the movement of the elevation base 23.

The Y-axis direction conveyor 30 preferably is a feed screw mechanism including a Y-axis direction feed screw rod 31, a Y-axis direction feed motor 32, and a feed nut 33. The Y-axis direction feed screw rod 31 extends in the Y-axis direction. The Y-axis direction feed screw rod 31 is provided at the elevation base 23. The Y-axis direction feed screw rod 31 is provided with a spiral screw groove. A rear end of the Y-axis direction feed screw rod 31 is coupled with the Y-axis direction feed motor 32. The Y-axis direction feed motor 32 is an electric motor. The Y-axis direction feed motor 32 is connected with the controller 60. The Y-axis direction feed motor 32 is secured to a rear portion of the elevation base 23. The Y-axis direction feed motor 32 rotates the Y-axis direction feed screw rod 31. The nut 33, which include threads, is geared with the screw groove of the Y-axis direction feed screw rod 31. The elevation base 23 includes two slide shafts 23b and 23c extending in the Y-axis direction. The two slide shafts 23b and 23c are provided parallel or substantially parallel to the Y-axis direction feed screw rod 31. The slide shafts 23b and 23c support a slide base 24 such that the slide base 24 is slidable in the Y-axis direction. When the Y-axis direction feed motor 32 is driven, the Y-axis direction feed screw rod 31 is rotated, and thus the slide base 24 moves forward and rearward along the slide shafts 23b and 23c.

The X-axis direction conveyor 40 preferably is a feed screw mechanism including an X-axis direction feed screw rod 41, an X-axis direction feed motor 42, and a feed nut (not shown). The X-axis direction feed screw rod 41 extends in the X-axis direction. The X-axis direction feed screw rod 41 is provided to the front of the slide base 24. The X-axis direction feed screw rod 41 is provided with a spiral screw groove. An end of the X-axis direction feed screw rod 41 is coupled with the X-axis direction feed motor 42. The X-axis direction feed motor 42 is an electric motor. The X-axis direction feed motor 42 is connected with the controller 60. The X-axis direction feed motor 42 is secured to a portion of the right wall that extends to the front of the slide base 24. The X-axis direction feed motor 42 rotates the X-axis direction feed screw rod 41. The nut, which includes threads, is geared with the screw groove of the X-axis direction feed screw rod 41. To the front of the slide base 24, two slide shafts 24b and 24c are provided along the X-axis direction. The two slide shafts 24b and 24c are provided parallel or substantially parallel to the X-axis direction feed screw rod 41. The slide shafts 24b and 24c support the carriage 11 such that the carriage 11 is slidable in the X-axis direction. When the X-axis direction feed motor 42 is driven, the X-axis direction feed screw rod 41 is rotated, and thus the carriage 11 moves leftward and rightward along the slide shafts 24b and 24c.

The carriage 11 includes a decoration head 12, a heater 15, and a motor (not shown). The decoration head 12 is located in a front portion of the carriage 11. The decoration head 12 is located above the work carrying region 2b. The decoration head 12 is cylindrical. A bottom end of the decoration head 12 is capable of detachably grasping a decoration tool 13 (i.e., a foil stamping tool or an imprinting tool).

The foil stamping tool presses a hot stamp foil onto the work WK. The foil stamping tool is an example of foil transfer tool. The foil stamping tool is rod-shaped. A tip of the foil stamping tool closer to the work WK is made of a material having a high heat conductivity, for example, a metal material. The imprinting tool performs imprinting onto the work WK. The imprinting tool is circular rod-shaped. A tip of the imprinting tool closer the work WK is made of a material harder than the work WK, for example, artificial diamond, cemented carbide or the like. The tip of the imprinting tool closer to the work WK may have a smaller contact area size with the work WK than the contact area size of the tip of the foil stamping tool closer to the work WK. The imprinting tool may have a higher pressing force than the foil stamping tool.

The decoration head 12 grasps the decoration tool 13 such that the decoration tool 13 is movable upward and downward. Specifically, the decoration head 12 includes a solenoid (not shown) and a spring (not shown). The solenoid is connected with the controller 60. When the controller 60 drives the solenoid, the decoration tool 13 located inside the decoration head 12 protrudes downward. As a result, the decoration tool 13 contacts the work WK. The spring is located below the solenoid. The spring urges the decoration tool 13 located in the decoration head 12 upward. When the driving of the solenoid is stopped, the decoration tool 13 moves upward by the urging force of the spring. As a result, the decoration tool 13 is separated from the work WK.

More specifically, the solenoid is driven in the state where the decoration head 12 grasps the foil stamping tool, so that the foil stamping tool presses the work WK via a hot stamp foil. The carriage 11 is moved with respect to the work WK while the foil stamping tool presses the work WK. As a result, a desired pattern is foil-stamped onto the surface of the work WK. The solenoid is driven/stopped in the state where the decoration head 12 grasps the imprinting tool, so that the imprinting tool strikes the work WK. The carriage 11 is moved with respect to the work WK while the imprinting tool strikes the work WK. As a result, the surface of the work WK is imprinted as desired.

The heater 15 is connected with the controller 60. When the controller 60 drives the heater 15, at least the tip of the foil stamping tool closer to the work WK is heated to a predetermined temperature.

The overall operation of the decoration device 1 is controlled by the controller 60. The controller 60 is communicably connected with the solenoid, the heater 15, the Z-axis direction feed motor 22, the Y-axis direction feed motor 32, and the X-axis direction feed motor 42, and is configured or programmed to control these components. The controller 60 is configured or programmed to define or include a foil stamping controller 61 and an imprinting controller 62. The foil stamping controller 61 is configured or programmed to move the decoration head 12 with respect to the work WK in the state where the decoration head 12 grasps the foil stamping tool, so as to press the hot stamp foil onto the work WK. The imprinting controller 62 is configured or programmed to move the decoration head 12 with respect to the work WK in the state where the decoration head 12 grasps the imprinting tool, so as to perform imprinting on the work WK.

There is no specific limitation on the structure of the controller 60. The controller 60 is typically a computer. The controller 60 includes, for example, an interface (I/F) receiving printing data or the like from an external device such as a host computer or the like, a central processing unit (CPU) executing an instruction from a control program, a ROM (read only memory) having, stored thereon, a program executable by the CPU, a RAM (random access memory) usable as a working area in which the program is developed, and a memory device (storage medium) such as a memory or the like storing various types of data.

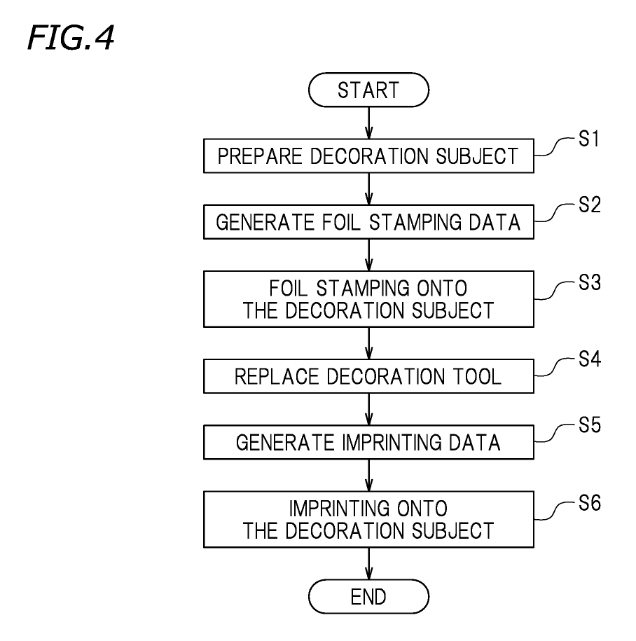

Now, a case where the decoration device 1 is used to decorate a decoration subject will be described. In this example, a surface, of a work WK, to be decorated is made of a resin material. FIG. 4 is a flowchart showing a decoration method according to a preferred embodiment. Before the decoration of the decoration subject, the user connects the host computer (not shown) and the decoration device 1 to each other, and turns on the power of the host computer and the power switch 2a of the decoration device 1. On the host computer, a foil stamping program and an imprinting program are stored in advance. The user inputs a set temperature for the heater 15 to the host computer. The heater 15 is heated to the set temperature by the controller 60.

In step S1, the user prepares the work WK as the decoration subject. The work WK is installed on the work carrying region 2b of the base 2. The work WK is secured to the work carrying region 2b by use of, for example, a securing tool WC. The user also prepares a hot stamp foil usable for foil stamping. The hot stamp foil may be, for example, a metallic foil, a half mirror metallic foil, a pigment foil, a multi-color printing foil, a hologram foil or the like conventionally known.

Next, in step S2, the user has the decoration head 12 grasp the foil stamping tool. The user places the hot stamp foil on the surface of the work WK. The user operates the host computer to instruct execution of the foil stamping program. The foil stamping program generates, when data on a pattern to be foil-stamped onto the work WK is input by the user, foil stamping data based on the data on the pattern. The data on the pattern input by the user is represented by, for example, a raster data (bit map data) format. The input data on the pattern is converted into foil stamping data. The foil stamping data is represented by, for example, a vector format. In the case where the data input by the user is of a vector format, the conversion step may be omitted. The foil stamping data is output to the foil stamping controller 61 of the controller 60.

Next, in step S3, the foil stamping controller 61 executes foil stamping based on the output foil stamping data. Specifically, the foil stamping controller 61 controls the actuation of each of the Z-axis direction feed motor 22, the Y-axis direction feed motor 32 and the X-axis direction feed motor 42 to move the foil stamping tool with respect to the work WK. The foil stamping controller 61 controls the actuation of the solenoid to put the tip of the foil stamping tool into contact with the hot stamp foil. The tip of the foil stamping tool has been heated to a predetermined temperature. The hot stamp foil is pressed by the tip of the foil stamping tool, so that a metallic layer or a pigment layer included in the hot stamp foil is transferred onto the surface of the work WK. As a result, the pattern is formed on the surface of the work WK.

Next, in step S4, the user replaces the decoration tool 13. Specifically, the user detaches the foil stamping tool from the decoration head 12, and has the decoration head 12 grasp the imprinting tool. In other words, the user exchanges the decoration tools 13.

Next, in step S5, the user operates the host computer to instruct execution of the imprinting program. The imprinting program generates, when data on a pattern to be imprinted onto the work WK is input by the user, imprinting data based on the data on the pattern. The data on the pattern input by the user is represented by, for example, a raster data (bit map data) format. The input data on the pattern is converted into imprinting data. The imprinting data is binary data representing, for example, the color darkness/paleness or the brightness (luminance) of the pattern. The imprinting data is output to the imprinting controller 62 of the controller 60.

Next, in step S6, the imprinting controller 62 executes imprinting based on the output imprinting data. Specifically, the imprinting controller 62 controls the actuation of each of the Z-axis direction feed motor 22, the Y-axis direction feed motor 32 and the X-axis direction feed motor 42 to move the imprinting tool with respect to the work WK. The imprinting controller 62 starts and stops the solenoid in repetition to cause the tip of the imprinting tool to strike the work WK, specifically, a surface of the foil-stamped pattern or a surface of the work WK that is not foil-stamped. At this point, for example, the pressing force of the tip of the imprinting tool or the imprinting interval (density) may be adjusted, so that the imprinting indentations having a depth in accordance with the color darkness/paleness or the brightness (luminance) of the pattern are formed. As a result, the pattern represented by the indentations is formed on the surface of the work WK.

As described above, the decoration device 1 according to this preferred embodiment gives a pattern to the work WK by foil stamping. In addition, the decoration device 1 performs imprinting, so as to allow the user to change the appearance of the pattern on the work WK as desired. Thus, for example, the metallic tone, luster, hue or the like of the pattern is freely adjustable. The decoration device 1 uses a combination of foil stamping and imprinting, so that a wide variety of creative designs are realized, and the diversity of representation is increased, unlike only foil stamping is used. Therefore, the decoration device 1 realizes any of a wide variety of wishes of a user and thus improves the degree of satisfaction of the users.

According to this preferred embodiment, one decoration head 12 is provided, and the one decoration head 12 is capable of detachably grasping the foil stamping tool or the imprinting tool. This makes the decoration device 1 compact, which saves space and decreases the number of components to lower the production cost.

According to this preferred embodiment, the decoration device 1 includes the heater 15 heating the foil stamping tool. The foil stamping controller 61 is configured or programmed to press the foil stamping tool heated by the heater 15 onto the hot stamp foil placed on the work WK. In this manner, the hot stamp foil is usable to form a pattern on the work WK with higher precision more stably.

According to this preferred embodiment, the Vickers hardness of the surface, of the work WK, to be decorated is about 200 or less. Therefore, the processability of the surface of the work WK is improved, and thus the surface of the work WK is processed by imprinting more stably.

With the decoration method according to this preferred embodiment, the imprinting controller 62 is configured or programmed to perform imprinting control after the foil stamping control is performed by the foil stamping controller 61 in the case where the surface, of the work WK, to be decorated is formed of a resin material. Therefore, the work WK including the resin surface is decorated more stably.

With the decoration method according to this preferred embodiment, a foil stamping step and an imprinting step are performed by use of the decoration device 1 decorating the work WK. The decoration device 1 includes the base 2 holding the work WK, one decoration head 12 grasping the foil stamping tool or the imprinting tool selectively, the conveyors 20, 30 and 40 moving either one of the base 2 and the decoration head 12 with respect to the other of the base 2 and the decoration head 12, and the controller 60 communicably connected with the decoration head 12 and the conveyors 20, 30 and 40, the controller 60 driving the decoration head 12 and the conveyors 20, 30 and 40. This decreases the positional shift between the foil stamping and the imprinting and thus allows the work WK to be decorated more stably. Therefore, the desired pattern is formed with higher precision.

The decoration method according to this preferred embodiment includes, between the foil stamping step and the imprinting step, a step of replacing the tool currently grasped by the decoration head 12. This further decreases the positional shift between the foil stamping and the imprinting and thus allows the work WK to be decorated with higher precision.

Preferred embodiments according to the present invention have been described. The above-described preferred embodiments are merely examples, and the present invention may be carried out in any of various preferred embodiments.

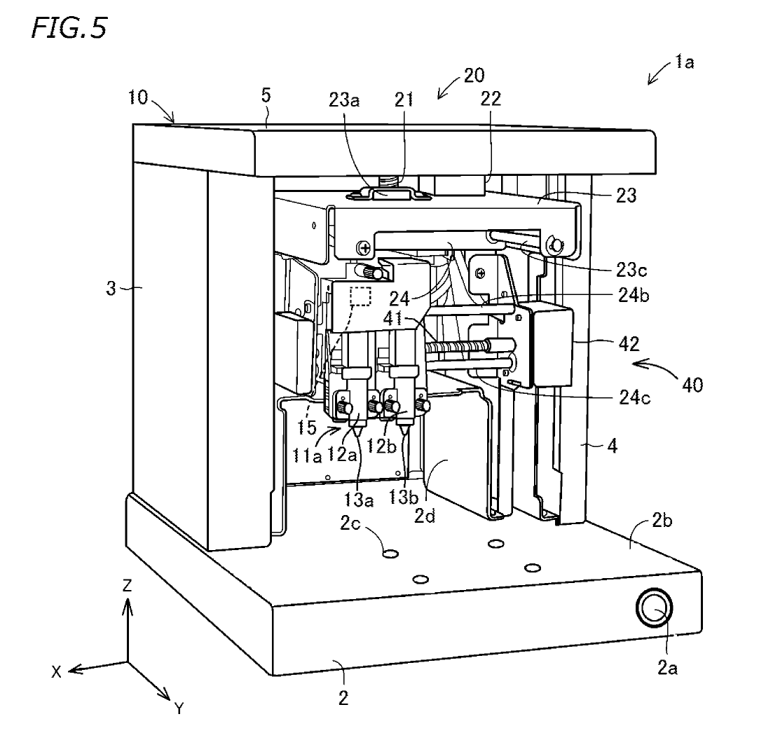

In the above-described preferred embodiments, the decoration device 1 includes one decoration head 12. The decoration device 1 is not limited to having such a structure. For example, as shown in FIG. 5, a decoration device 1a may include a decoration head 12a accommodating a foil stamping fool 13a and a decoration head 12b accommodating an imprinting tool 13b. The decoration head 12a and the decoration head 12b are mounted on a carriage 11a. In this case, step 4 described above may be omitted. In other words, the decoration device 1a does not need to replace the foil stamping tool 13a and the imprinting tool 13b with each other. Therefore, the operation of the user of replacing the tools with each other is not required, and thus the foil stamping and the imprinting are performed continuously. This improves the work efficiency. In the example of FIG. 5, the two decoration heads 12a and 12b are both mounted on the same carriage 11a. Alternatively, the two decoration heads 12a and 12b may be mounted on different carriages as separate components.

With the decoration method according to the above-described preferred embodiment, in step S4, the user replaces the decoration tool 13. The decoration method is not limited to this. For example, the decoration device 1 may include a magazine accommodating a plurality of the decoration tools 13 and may exchange the plurality of decoration tools 13. In this case, the decoration tools 13 may be automatically exchanged by a controller of the decoration device 1.

With the decoration methods according to the above-described preferred embodiments, the imprinting is performed after the foil stamping. The decoration method is not limited to this. For example, the foil stamping may be performed after the imprinting. Alternatively, the foil stamping may be performed after the imprinting, and then the imprinting may be performed again. In accordance with which of the foil stamping and the imprinting is performed first, different designs or different manners of representation are provided, and thus the diversity of design or representation is further increased.

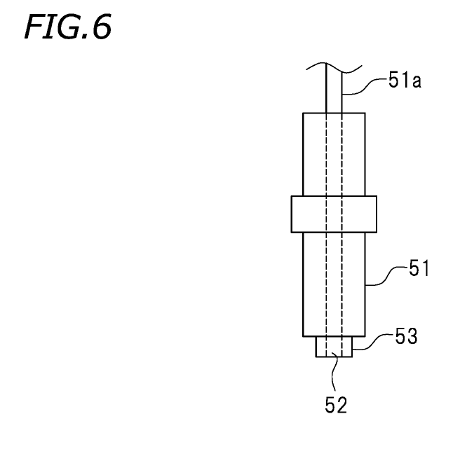

In the above-described preferred embodiments, the decoration device 1 is preferably structured such that the foil stamping tool as the foil transfer tool is grasped at the bottom end of the decoration head 12, and the foil stamping controller 61 presses the foil stamping tool onto the hot stamp foil placed on the work WK. The present invention is not limited to this. For example, a foil transfer tool 51 shown in FIG. 6 includes a laser output portion 52 and a pressing portion 53 both on a side facing the base 2 (on the side closer to the work WK). The laser output portion 52 is connected with a laser oscillation device (not shown) and directs laser light toward the work WK. The laser output portion 52 is an example of light output portion. The laser oscillation device is controlled by the foil stamping controller of the controller 60. The laser oscillation device is an example of light output device. The laser oscillation device is, for example, a semiconductor laser. The laser light output from the laser oscillation device is caused to pass the foil transfer tool 51 and is guided to a bottom surface of the foil transfer tool 51 by a fiber optic cable 51a. The laser light has a high response speed, and thus allows a light output state (ON) and a light non-output state (OFF) to be switched quickly and also allows the light intensity to be changed quickly. Therefore, even if, for example, the scanning speed of the foil transfer tool 51 is changed, the laser light is output homogeneously. The laser light output from the laser output portion 52 is, for example, blue. The light output device is not limited to a laser output device, and may be, for example, a light emitting diode (LED), a halogen lamp or the like. In this case, the foil stamping controller 61 may be configured or programmed to put the foil transfer tool 51 into contact with the hot stamp foil placed on the work WK and also to cause the laser output portion 52 to output laser light.

In the above-described preferred embodiments, the decoration head 12 is moved with respect to the work WK in the state where the decoration head 12 grasps the decoration tool 13. The present invention is not limited to this. The decoration device 1 may, for example, move the work WK with respect to the decoration head 12, or move both of the work WK and the decoration head 12 with respect to each other. For example, the work WK may be movable in the X-axis direction whereas the decoration head 12 may be movable in the Y-axis direction and the Z-axis direction. In the case where, for example, the work WK has a flat surface, the decoration device 1 may be secured in the Z-axis direction. In other words, the decoration device 1 does not need to include the Z-axis direction conveyor 20.

In the above-described preferred embodiments, a foil sheet for a hot stamp (hot stamp foil) preferably is used to perform the foil stamping. The present invention is not limited to this. The foil sheet may be, for example, a cold foil for a cold stamp. In this case, the tip of the foil stamping tool does not need to be heated. The decoration device 1 does not need to include the heater 15.

In the above-described preferred embodiments, the imprinting tool is used only for the imprinting. However, the tip of the imprinting tool closer to the work WK is made of a material having a high hardness. Therefore, the imprinting tool is usable also to measure the Vickers hardness of the surface, of the work WK, to be decorated. In this case, a program that measures the Vickers hardness may be stored on the controller 60 in advance. The controller 60 may be configured or programmed to move the decoration head 12 in the Z-axis direction with respect to the work WK based on the program that measures the Vickers hardness, in the state where the imprinting tool is grasped by the decoration head 12, so as to measure the Vickers hardness. The controller 60 may be configured or programmed to, when the Vickers hardness of the work WK is lower than, or equal to, a predefined reference value, start the decoration on the work WK and to, when the Vickers hardness of the work WK is higher than the predefined reference value, notify the user of that situation.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principle of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A decoration device for decorating a decoration subject by foil transfer and imprinting, the decoration device comprising:
a holding table holding the decoration subject;
at least one grasping tool grasping a foil transfer tool and/or an imprinting tool simultaneously or selectively;
a conveyor moving one of the holding table and the at least one grasping tool with respect to the other of the holding table and the at least one grasping tool; and
a controller communicably connected with the at least one grasping tool and the conveyor and configured or programmed to drive the at least one grasping tool and the conveyor; wherein
the controller is configured or programmed to include:
a foil transfer controller configured or programmed to move the grasping tool grasping the foil transfer tool and the holding table with respect to each other by use of the conveyor to execute foil transfer control to perform foil transfer onto the decoration subject; and
an imprinting controller configured or programmed to move the grasping tool grasping the imprinting tool and the holding table with respect to each other by use of the conveyor to execute imprinting control to perform imprinting onto the decoration subject; and
the imprinting controller is configured or programmed to execute the imprinting control at least either before the foil transfer control by the foil transfer controller or after the foil transfer control by the foil transfer controller.

2. The decoration device according to claim 1, wherein the at least one grasping tool includes one grasping tool that detachably grasps the foil transfer tool or the imprinting tool.

3. The decoration device according to claim 1, wherein the at least one grasping tool includes at least two grasping tools including a first grasping tool that grasps the foil transfer tool and a second grasping tool that grasps the imprinting tool.

4. The decoration device according to claim 1, wherein the imprinting controller is configured or programmed to perform the imprinting control after the foil transfer control by the foil transfer controller when the decoration subject has a resin surface to be decorated.

5. The decoration device according to claim 1, further comprising a heater heating the foil transfer tool;
wherein the foil transfer controller is configured or programmed to press the foil transfer tool heated by the heater onto a foil sheet placed on the decoration subject.

6. The decoration device according to claim 1, wherein:
the foil transfer tool includes a light output portion connected with a light output device; and
the foil transfer controller is configured or programmed to put the foil transfer tool into contact with the foil sheet placed on the decoration subject and to cause the light output portion to output light.

7. A decoration method for decorating a decoration subject, the method comprising:
a foil transfer step of performing foil transfer to the decoration subject; and
an imprinting step of performing imprinting on the decoration subject before or after the foil transfer step.

8. The decoration method according to claim 7, wherein a surface of the decoration subject that is to be decorated has a Vickers hardness of 200 or less.

9. The decoration method according to claim 7, wherein the foil transfer step and the imprinting step are performed by use of a decoration device including a holding table holding the decoration subject, at least one grasping tool grasping a foil transfer tool and/or an imprinting tool simultaneously or selectively, a conveyor moving one of the holding table and the at least one grasping tool with respect to the other of the holding table and the at least one grasping tool, and a controller communicably connected with the at least one grasping tool and the conveyor and configured or programmed to drive the at least one grasping tool and the conveyor.

10. The decoration method according to claim 9, further comprising a replacement step of replacing the foil transfer tool with the imprinting foil or replacing the imprinting foil with the foil transfer tool, the replacement step being performed between the foil transfer step and the imprinting step.
